(19) United States
(12) Patent Application Publication
(10) Pub. No.: US 2008/0070228 A1
(43) Pub. Date: Mar. 20, 2008

(54) Versatile Messaging System

(76) Inventor: Matthew J. Gerules, Chicago, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/533,242

(22) Filed: Sep. 19, 2006

(51) Int. Cl. B43L 1/00

(52) U.S. Cl. 434/408

(57) ABSTRACT

A messaging system comprises a message board, a freestanding support structure, and an instrument storage surface. The message board has a messaging surface adapted to at least temporarily presenting messages. The freestanding support structure is adapted to support the message board for display on a horizontal surface. The instrument storage surface is disposed behind the message board relative to the messaging surface such that the instrument storage surface is adapted to store a writing instrument in a position that is substantially hidden when the messaging surface is viewed.

### FIELD OF THE DISCLOSURE

The present disclosure relates to message boards and, more particularly, to messaging systems having message boards constructed and arranged to at least temporarily present a message.

### BACKGROUND

Typical message boards include chalkboards, cork boards, pin hoards and dry-erase boards. These boards are generally constructed and arranged to adhere or otherwise hang from a vertical surface, or to be free-standing. Additionally, these boards may be configured to support a tray, dish, or clip, for example, to store pens, markers, erasers, thumb tacks, and the like. Hanging message boards generally include the tray, dish, or clip disposed along a side, top, or bottom thereof in an easily accessible and visible position.

One conventional hanging message board includes a dry-erase board capable of being mounted to a vertical surface and having a marker clip. The adhesive component used to mount the board typically includes a piece of double-sided tape on the back of the board to stick to a wall or a door or some other substantially vertical surface. The marker clip is often affixed to the top edge of the board such that it is readily visible and accessible. The marker clip is adapted to releasably secure a marker such that a user may easily remove, use, and replace the marker for subsequent use.

Another conventional hanging dry-erase board includes a loop such as a piece of string or wire for hanging. The string or wire may be disposed around a door knob, a cabinet handle, or any other suitable location in the home or office. Similar to the board mentioned above, such hanging dry-erase boards also often include a readily visible and useable marker clip for releasably storing a marker or other writing instrument.

Although such hanging dry-erase boards having such storage are functionally desirable, the readily visible location of the marker clip or tray detracts from any aesthetic appeal the messaging boards might otherwise have. Additionally, while the hanging message boards may be hung on virtually any vertical surface, changing the location of the message board is not always practical, particularly when the message board is adhered to the vertical surface.

Conventional freestanding message boards include freestanding chalkboards and dry-erase boards, for example, supported by rigid legs. Such freestanding message boards can also include wheels for movement about a room. Many of these message boards include trays along a bottom edge thereof for retaining writing instruments such as chalk and markers. While such boards are often utilized in conference rooms and classrooms, they are generally relatively large and cumbersome. Thus, such devices are not reasonably available for home, countertop, or tabletop use. Additionally, these products are not very fashionable, but rather, are aesthetically utilitarian and institutional.

Another freestanding message board includes tabletop or desktop message boards having a dry-erase surface. Such products may include a storage compartment integrally formed below the dry-erase board for storing writing instruments and accessible through a side window having a hinged door. These freestanding table-top message boards are conventionally used lying flat on a table and written or drawn on similarly to any conventional writing pad or tablet. While such tabletop or desktop devices are relatively mobile, they are incapable of being arranged for display. Rather, as the devices are supported on a desk, or a table, only the user looking directly down onto the messaging surface may read what is presented thereon. Further yet, such message boards lack any structure enabling them to be free-standing. Finally, although such tabletop or desktop message boards often include compartments for storing markers, pencils, and/or pens, etc., such storage is not readily accessible.

### SUMMARY

One aspect of the present disclosure provides a messaging system including a message board, a freestanding support structure, and an instrument storage surface. The message board has a messaging surface constructed and arranged to at least temporarily present messages. The freestanding support structure supports the message board. In some embodiments the message board is integrally connected to the freestanding support structure. In other embodiments, the message board is removably secured to the freestanding support structure. The instrument storage surface is disposed opposite the message board from the messaging surface such that a marker or other writing instrument stored thereon or therein is generally hidden from view, as described in further detail below.

In accordance with another aspect, the messaging system further includes a marker for storage on or in the instrument storage surface.

In accordance with another aspect, the instrument storage surface is integrally formed with the freestanding support structure.

In accordance with another aspect, the message board and the freestanding support structure are integrally formed as one piece.

In accordance with another aspect, the support structure is pivotally coupled to the message board such that the messaging system is positionable in a display configuration and a writing configuration.

In accordance with yet another aspect, the message board extends from the freestanding support structure at an angle away from the messaging surface.

In accordance with still another aspect, the message board is cantilevered from the support structure.

In accordance with a further aspect, the instrument storage surface comprises a concave surface formed on the freestanding support structure, and is positioned behind the message board.

In accordance with a still further aspect, the freestanding support structure includes a cavity that may or may not be integrally formed therein and the instrument storage surface is disposed in the cavity.

In accordance with still yet another aspect, the messaging surface includes a dry-erase surface.

In accordance with a still further aspect, the message board is detachable from the support structure such that the message board can be easily removed and replaced with another message board.

### BRIEF DESCRIPTION OF THE DRAWINGS

FIG. 1 is a rear perspective view of one embodiment of a messaging system constructed and arranged in accordance with the principles of the present disclosure;

FIG. 2 is a side view of the messaging system of FIG. 1;

FIG. 3 is a front perspective view of a second embodiment of a messaging system constructed and arranged in accordance with the principles of the present disclosure;

FIG. 4 is a side view of the messaging system of FIG. 3;

FIG. 5 is a cross-sectional side view of the messaging system of FIGS. 3 and 4 taken through line 5-5 of FIG. 3;

FIG. 6 is a front perspective view of a third embodiment of a messaging system constructed and arranged in accordance with the principles of the present disclosure;

FIG. 7 is a cross-sectional side view of the messaging system of FIG. 6 taken through line 7-7 of FIG. 6;

FIG. 8 is a side view of a fourth embodiment of a messaging system constructed and arranged in accordance with the principles of the present disclosure;

FIG. 9 is a front perspective view of a fifth embodiment of a messaging system constructed and arranged in accordance with the principles of the present disclosure having a support structure positioned in a display configuration;

FIG. 10 is a rear perspective view of the messaging system of FIG. 9; and

FIG. 11 is a side view of the messaging system of FIGS. 9 and 10 wherein the support structure is positioned in a stored configuration.

### DETAILED DESCRIPTION

The present disclosure provides a compact, mobile, and decorative, freestanding messaging system. The messaging system provides a messaging surface adapted to selectively and at least temporarily present messages or display on a horizontal surface such as a countertop, a desktop, or some other flat surface. Advantageously, the messaging system provides the messaging surface at an angle relative to the horizontal surface, thereby enhancing the presentation and providing a reader-friendly message. Furthermore, the messaging system disclosed herein provides a storage compartment for one or more writing instruments that are adapted to be used with the messaging surface. The storage compartment is constructed and arranged in a manner that conceals the writing instrument out of view from an individual reading the messaging surface. Such concealed storage adds to the aesthetic appeal of the messaging system. Thus, the messaging system is compact, mobile and versatile. The versatility of the messaging system further arises from the ability to assemble the messaging system with different messaging surfaces tailored to different themes, motifs, tastes, or decorations.

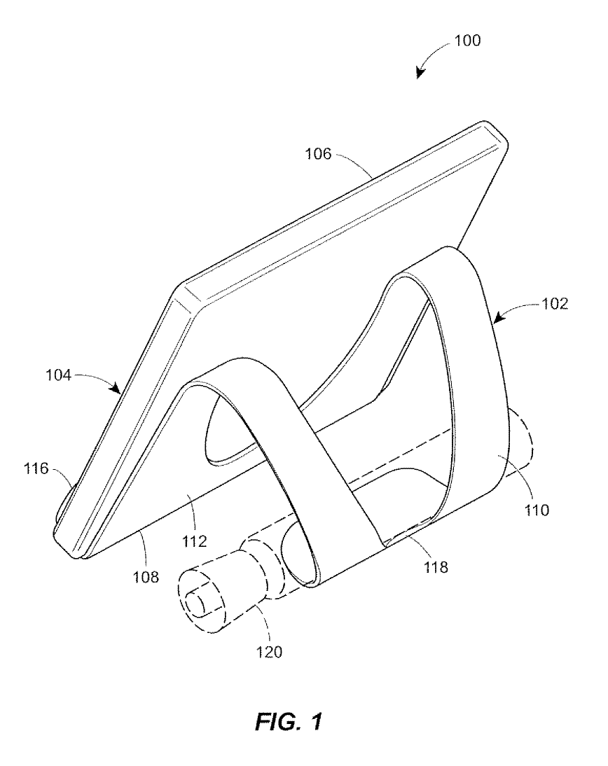

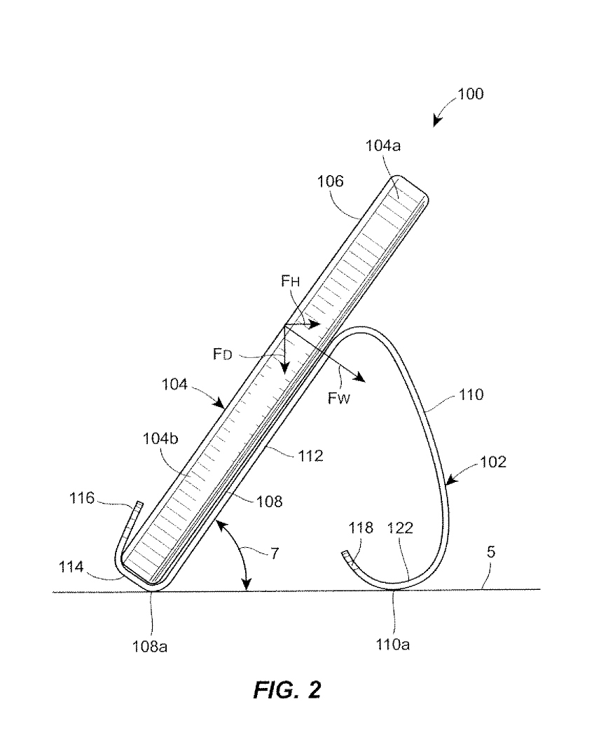

FIG. 1 depicts a messaging system 100 constructed and arranged in accordance with the principles of the present disclosure. The messaging system 100 generally includes a support structure 102 and a message board 104. The support structure 102 is adapted to support the message board 104 on a flat horizontal surface 5 (shown in FIG. 2) such as a kitchen counter, an office desk, a table, or any other practical location. The message board 104 includes a generally square body having a messaging surface 106 adapted to temporarily present messages, but the shape of the message board body need not be so limited. In one embodiment of the messaging system 100, the messaging surface 106 includes a dry-erase surface. The dry-erase surface is adapted to temporarily present messages handwritten or drawn with a dry-erase marker such as a dry-erase EXPO® marker available from Sanford, L. P. (Oakbrook, Ill.). In the event the user chooses to remove the message, the user may do so by simply wiping the messaging surface 106 with a cloth, tissue, or other suitable material. In other embodiments, the messaging surface may include a chalkboard, a glass substrate, a ceramic tile, a cork-board and/or other substrates including surfaces or materials capable of temporarily or permanently presenting messages.

With continued reference to FIG. 1 and also to FIG. 2, the message board 104 includes a top portion 104a and a bottom portion 104b. The support structure 102 of the messaging system 100 generally comprises a one-piece member, but individual, coupled pieces may be used to the same effect. The support structure 102 comprises a single piece, and includes a seat portion 108 and a log portion 110. The seat portion 108 includes a supporting surface 108a, a back plate 112, a seat plate 114, and a retainer plate 116. The leg portion 110 also includes a supporting surface 110a. The supporting surfaces 108a, 110a of the seat portion 108 and leg portion 110, respectively, engage the horizontal surface 5 to support the messaging device 100. The back plate 112 of the seat portion 108 extends from the supporting surface 108a and the horizontal surface 5 at an angle, which is represented by reference numeral 7 in FIG. 2. In one embodiment, for example, the angle 7 can be generally any angle between approximately 45 degrees and approximately 75 degrees. It should be understood, however, that the angle 7 may be any angle capable of serving the principles of the present disclosure.

As shown in FIG. 2 the seat plate 114 of the seat portion 108 extends between the back plate 112 and the retainer plate 116. The back plate 112, seat plate 114, and retainer plate 116, therefore provide the seat portion 108 with a generally U-shaped or hook-shaped side cross-section near the bottom portion 104b of the message board 104. This geometry enables the seat portion 108 to receivingly support the bottom portion 104b of the message hoard 104, as depicted and described in more detail below. Additionally, the top portion 104a of the message board 104 can therefore extend beyond the support structure 102. More specifically, the top portion 104a of the message board 104 can be cantilevered at the angle 7 beyond the support structure 102 due to the angle 7 of the back plate 112 of the seat portion 108, and one ability of the seat portion 108 is to receivingly support the message board 104. Still further, the message board 104 may be removed from the seat potion 108.

Still referring to FIG. 2, the leg portion 110 generally provides the support surface 110 as well as a storage component 118. The storage component 118 is adapted to store, for example, a marker 120, as depicted in phantom in FIG. 1. The storage component 118 in the embodiment depicted in FIGS. 1 and 2 comprises a curved member extending from the leg portion 110 of the support structure 102 toward the seat portion 108. The storage component 118 is disposed behind the back plate 112, and is therefore concealed relative to the message board 104. In the embodiment depicted, the storage component 118 includes an elongated concave surface 122. The elongated concave surface 122 of the disclosed embodiment is adapted to receivingly support and retain the marker 120, for example, in a position that is substantially hidden or out of view from an individual having a perspective directed at the messaging surface 106 of the message board 104 when properly oriented for use. As shown in FIG. 1, for example, the leg portion 110 also conceals the marker 120, to a limited extent, from an individual having a perspective toward the backside of the messaging system 100. While the leg portion 110 is disclosed in FIG. 1 as comprising generally two leg portions separated by an open window portion, an alternative embodiment of the messaging system 100 may include a solid leg portion 110. Such a solid leg portion 110 may completely conceal the marker 120 from the view of an individual. Furthermore, the elongated concave surface 122 of the disclosed embodiment provides an easily accessible storage component 118, which makes storage and retrieval of the marker 120 simple and efficient.

As stated above, the message board 104 of the embodiment disclosed in FIGS. 1 and 2 may include a dry-erase board, a chalkboard, a glass substrate, a ceramic tile, a cork-board and/or other substrates including surfaces or materials capable of temporarily or permanently presenting messages. In an alternative embodiment of the messaging system 100, the message board 104 may be interchangeable with one or more auxiliary message boards 104. For example, the message board 104 having a dry-erase surface 106 may be replaced by a message board 104 having a chalkboard messaging surface 106, a corkboard messaging surface 106, a glass messaging surface 106, or any other suitable surface or combination of such surfaces. Similarly, the message board 104 may be replaced by a plurality of ceramic tiles. Further yet, the message board 104 may be replaced by another message board of similar or different core construction and also having a specific motif or theme depicted thereon. The theme or motif may include a religious or national holiday motif, a birthday motif, a seasonal motif representative of spring, summer, fall, or winter, a school or institutional motif, or any other motif or collection of indicia, graphics, and/or lettering that may foreseeably be desired by consumers. For example, the messaging system 100 could be combined with a plurality of interchangeable message boards 104, each depicting a different season.

Thus, in contrast to conventional messaging devices, which are restricted to a single type of messaging surface, the messaging system 100 of the present disclosure is variably versatile to accommodate particular consumer tastes. Whereas conventional message boards may require consumers to purchase multiple messaging devices in order to display multiple themes or motifs, the messaging system 100 of the present disclosure is not so limited. For example, restaurateurs often populate a menu board not only with the specials entrees of the day, but also with ornamental décor, which may reflect a holiday season, a celebration, or some other special occasion. With conventional message boards, restaurateurs must spend ample time drawing or stenciling the decor onto the boards. Such a system may be deemed wasteful as the season or celebration is often reoccurring, and therefore the owner needs to redraw the same or similar motif for the next celebration. The messaging system 100 disclosed herein reduces this inefficiency by providing an easily interchangeable system capable of providing a message board predecorated for the particular season, holiday, and/or celebration, etc.

The support structure 102 of the embodiment disclosed generally comprises a stamped sheet metal structure. In an alternate embodiment, the support structure 102 includes a rolled or extruded sheet metal structure. However, it should be appreciated that in further alternative embodiments, the support structure may include a machined metal structure, a molded structure or the support structure may be constructed of generally any material by any process capable of serving the principles of the present disclosure. For example, the support structure 102 may include an extruded or machined/thermoformed plastic sheet.

As mentioned, the support surfaces 108a and 110a of the support structure 102 support the messaging system 100 on the horizontal surface 5. The angle 7 that the seat portion 108 extends from the horizontal surface 5 inherently generates a moment acting on the seat portion 108. This moment acts in the clockwise direction relative to the orientation of the seat portion 108 shown in FIG. 2. The leg portion 110 therefore counteracts the moment to maintain the predetermined angular disposition of the back plate 112 of the seat portion 108 and prevent the seat portion 108 from tipping.

Additionally, it should be appreciated that a similar moment acts in the clockwise direction on the message board 104 when seated in the seat portion 108 as depicted. This is attributable to the angle 7 of the seat portion 108. The leg portion 110 counteracts this moment acting on the message board 104 to maintain its predetermined disposition and prevent it from tipping. Furthermore, the retainer plate 116 of the disclosed embodiment of the seat portion 108 can counteract this moment acting on the message board 104. Specifically, as the moment acts in the clockwise direction relative to the orientation of the message board 104 depicted in FIG. 2, the bottom portion 104b of the message board 104 applies a force in the clockwise direction or to the left of the message board 104 depicted in FIG. 2. The retainer plate 116 is therefore statically disposed along the direction of this force to aid in maintaining the predetermined angle 7 of the message board 104. This balancing of the moments is directly attributable to the angle 7 of the seat portion 108 and the relationship of the leg portion 110 extending therefrom and engaging the surface 5.

Furthermore, during use and while a user applies a writing force Fw to the messaging surface 106 of the message board 104, the leg portion 110 and seat portion 108 and, more particularly, the retainer plate 116 of the seat portion 108, work in cooperation to maintain the desired positioning of the message board 104. Specifically, as the writing force Fw is applied to the messaging surface 106 in, for example, a horizontal direction, the angle 7 of the messaging board 104 converts the writing force Fw into a downward component F_{D} and a horizontal component F_{H}. The downward component F_{D} of the disclosed embodiment generates sufficient force directed into the surface 5 to thereby increase a frictional force between the support structure 102 and the surface 5 to prevent the writing force F_{W} from moving the messaging system 100 along the surface 5. Additionally, it should be appreciated that the angle 7 of the disclosed embodiment also enhances viewing of the messaging board 104 by directing the messaging surface 106 upward toward the eyes of an adult observer. For example, as mentioned above, the angle 7 may include an angle between approximately 45 degrees and approximately 75 degrees.

While the above-embodiment includes the retainer plate 116 working in cooperation with the leg portion 110 and seat portion 108 to maintain the disposition of the message board 104, an alternative embodiment may include a support structure lacking a retainer plate 116. Such a support structure may include a seat portion 108 disposed at an angle sufficient to maintain the disposition of the message board itself or alternatively a side plate disposed along support surface 112 or a top plate for retaining the message board 104. Still another alternative embodiment may include a message board 104 shaped and sized to maintain its disposition. For example, an alternative form of the message board 104 may include a message board having a varying thickness such that the bottom is thicker than the top, thereby reducing the magnitude and location of the moment generated therefrom, and thus the commensurate need for corresponding structure to counteract the same.

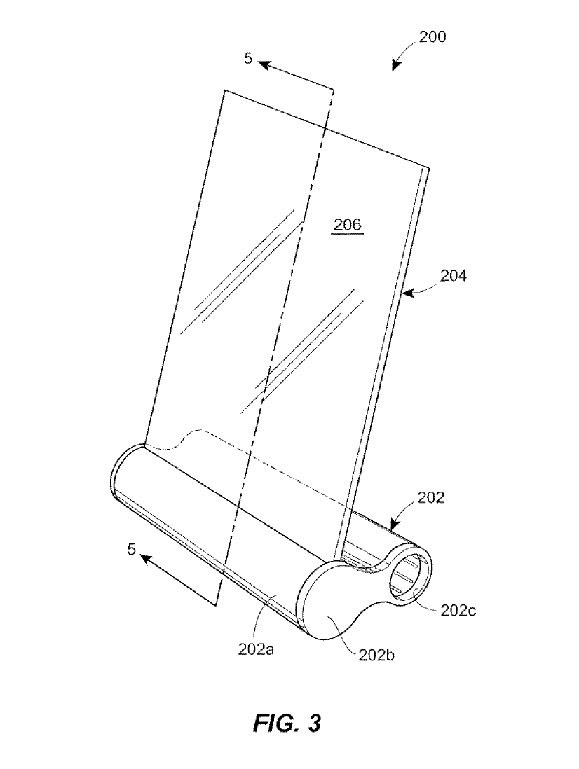

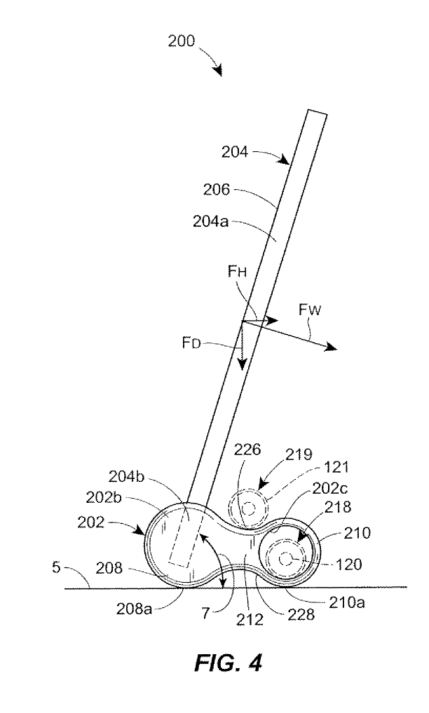

FIGS. 3-5 depict another messaging system 200 constructed and arranged in accordance with the present disclosure. Similar to the messaging system 100 described above the messaging system 200 generally includes a support structure 202 and a message board 204. The support structure 202 is adapted to support the message board 204 on a flat horizontal surface 5 (shown in FIG. 4) such as a kitchen counter, a office desk, a table, or any other practical location. The message board 204 includes a generally rectangular member having a messaging surface 206 adapted to temporarily present messages. The message board 104 may, however, comprise a messaging surface of any known geometry. As previously described above with respect to messaging surface 106, various embodiments of the messaging surface 206 may include a dry-erase surface, a chalkboard, a glass substrate, a ceramic tile, a cork-board and/or other substrates including surfaces or materials capable of temporarily or permanently presenting messages.

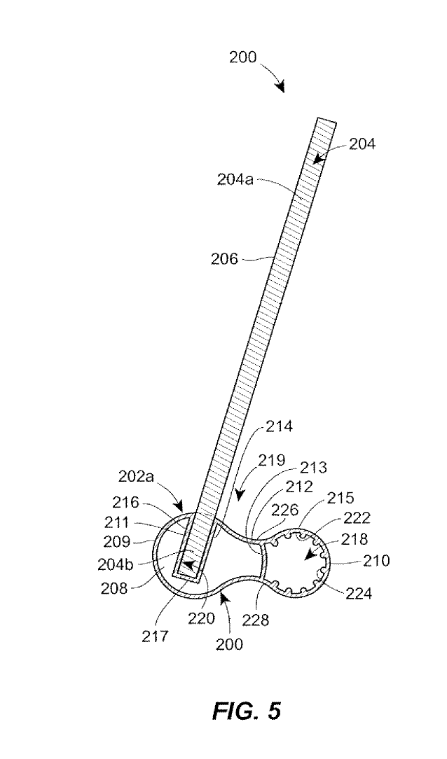

With reference to FIGS. 4 and 5, the message board 204 includes a top portion 204a and a bottom portion 204b. The support structure 202 of the messaging system 200 generally includes a one-piece main body 202a and one or more protective sidewalls 202b coupled thereto (shown in FIGS. 3 and 4). The one-piece main body 202a has a hollow tube-like geometry. In one embodiment, the sidewalls 202b snap onto or otherwise fixedly attach to the main body 202a, as will be discussed in greater detail below.

The one-piece support structure 202 includes a seat portion 208 and an arm portion 210. The seat portion 108 and arm portion 210 each include generally hollow cylindrical bodies extending parallel to each other and joined by a transition portion 212. In the exemplified embodiment shown in FIGS. 3-5, the transition portion 212 includes a web 213 disposed within the support structure 202 between the seat portion 208 and the arm portion 210. In the embodiment depicted in FIGS. 3-5, the arm portion 210 has a cross-sectional diameter that is slightly smaller than a cross-sectional diameter of the seat portion 208. The transition portion 212 extends between and integrally connects the seat portion 208 and the arm portion 210. The transition portion 212 includes an upper concave surface 226 and a lower concave surface 228. The upper and lower concave surfaces 226, 228 are disposed between the seat portion 208 and the arm portion 210 and have a width dimension substantially equal to a width dimension of the support structure 202 such that the support structure 202 has a figure-eight-type shaped cross-section.

The cylindrical body of the seat portion 208 includes an outer shell 209 and an inner seating member 211. The outer shell 209 includes a supporting surface 208a. The inner seating member 211 includes a back plate 214, a front plate 216, and a bottom plate 217. The bottom plate 217 extends between and connects the back plate 214 and front plate 216. The back plate 214, font plate 216, and bottom plate 217 define a slot 220 having a generally rectangular or U-shaped cross-section, although the specific shape need not be so limited. The slot 220 is adapted to receive and support the bottom portion 204b of the message board 204. The arm portion 210 of the support structure 202 includes an outer shell 215 and a storage component 218. The outer shell 215 includes a supporting surface 210a. The supporting surfaces 208a, 210a of the seat portion 208 and the arm portion 210 engage the horizontal surface 5 to support the messaging device 200. The slot 220 defined in the seat portion 208 of the support structure 202 extends from the horizontal surface 5 at an angle, which is represented by reference numeral 7 in FIG. 4. As mentioned above, the angle may be generally any angle between, for example, approximately 45 degrees and approximately 75 degrees.

With reference to FIG. 5, the arm portion 210 comprises the outer shell 215 and the storage component 218. The storage component 218 is a generally hollow cylindrical member bound by the web 213 of the transition portion 212 and by the inside surfaces of the outer shell 215. The storage component 218 is adapted to store, for example, a marker 120, as depicted in phantom in FIG. 4. In the embodiment depicted in FIGS. 4 and 5, the storage component 218 of the arm portion 210 includes an inner cylindrical surface 222 and a plurality of elongated ribs 224. The plurality of elongated ribs 224 extend from the inner cylindrical surface 222 and along the length of the arm portion 210, and help facilitate withdrawal and replacement of the stored marker, as explained in further detail below.

As mentioned above the sidewalls 202b snap onto or otherwise fixedly attach to the main body 202a of the support structure 202. In the embodiment illustrated in FIGS. 3-5, the sidewalls 202b include openings 202c providing access to the storage component 218. The openings 202c in the sidewalls 202b have diameters that are slightly smaller than a diameter of the inner cylindrical surface 222 of the storage component 218. In the exemplified embodiment of FIGS. 3-5, the diameter of the openings 202c is approximately equal to a diameter of a theoretical cylinder formed by the plurality of elongated ribs 224. Accordingly, in the exemplified embodiment of FIGS. 3-5, the fibs 224 raise the marker 120 off of the inner cylindrical surface 222 to enable easy insertion and removal thereof clear from obstruction caused by the perimeter surface of sidewalls 202b. Still further, the sidewalls 202b of an exemplified embodiment may be constructed of a rubber-like material and having outer dimensions slightly larger than outer dimensions of the main body 202a of the support structure 202. So constructed, the sidewalls 202b would directly engage the surface 5 on which the messaging device 200 stands. Such direct engagement generates friction between the support component 202 and the surface 5 while a user applies a force through a writing instrument to the messaging surface 206, and thereby prevents the messaging system 200 from sliding. In yet another alternative embodiment, the elongated ribs 224, in combination with the web 213, may also increase the integrity of the Support structure 202.

While the storage component 218 of the messaging device 200 has just been described as being defined by the inner cylindrical surface 222 and elongated ribs 224 of the arm portion 210, it should be understood that alternatively or additionally, the upper concave surface 226 of the transition portion 212 may serve as a storage component 219. The storage component 219 provided by the upper concave surface 226 is adapted to store a marker 121, for example, as depicted in phantom in FIG. 4. Accordingly, the storage components 218, 219 of the messaging device 200 depicted in FIGS. 3-5 are each adapted to receivingly support and retain a marker 120, 121, for example, in a position that is substantially hidden or out of view from an individual with a perspective directed at the messaging surface 206 of the message board 204. Specifically, to an individual viewing the messaging board 204, the messaging board 204 itself substantially hides the markers 120 and 121 from view. Furthermore, both the message board 204 and the outer shell 215 of the support structure 202 hides the marker 120. The outer shell 215 of the support structure 202 also substantially hides the marker 120 from an individual viewing the messaging device 200 from the top or the rear. Furthermore, the storage components 218, 219 provide easily accessible locations to store the markers 120, 121 for ready withdrawal and use.

Additionally, while the support structure 202 of the messaging device 200 depicted in FIGS. 3-5 has been disclosed in FIG. 4 as having an open ended am portion 210 defined by the openings 202c in the sidewalls 202b, an alternate embodiment of the support structure 202 may further include a cap that is removably insertable into the openings 202c. So configured, the cap would completely close the storage component 218 and further conceal the marker 120, for example. The cap could be coupled to the sidewall 202b by a living hinge, if desired. Also, one surface of the sidewalls 202b may not include an opening 202c, i.e., it may provide a solid sidewall.

The support structure 202 of the embodiment disclosed may be constructed as an extruded aluminum support structure 202. However, in an alternate embodiment, the support structure 202 may be constructed of plastic such as an injection molded plastic. In other alternative embodiments, the support structure 202 may comprise a machined plastic or forged metal structure or the support structure 202 may be constructed of generally any material by any process capable of serving the principles of the present disclosure.

Now, with reference to FIGS. 4 and 5 and as mentioned above, the slot 220 defined by the inner seating member 211 of the seat portion 208 of the support structure 202 receivingly supports the bottom portion 204b of the message board 204. The top portion 204a of the message board 204 therefore extends beyond the support structure 202. The top portion 204a of the message board 204 is cantilevered at the angle 7 beyond the support structure 202. The support surfaces 208a and 210a of the support structure 202 support the messaging device 200 on the horizontal surface 5. Additionally, the message board 204 may be removed from the seat portion 208. Similar to that described above with respect to the messaging system embodiment depicted in FIGS. 1 and 2, the angle 7 that the slot 220 in the seat portion 208 extends from the horizontal surface 5 inherently generates a moment acting on the message board 204 (when a message board is inserted therein). This moment acts in the clockwise direction relative to the orientation of the message board 204 of FIG. 5. The arm portion 210 and, more particularly, the support surface 210a on the arm portion 210 counteracts this moment to maintain the predetermined disposition of the messaging system 200 and to prevent the message board 204 from tipping in the clockwise direction relative to its orientation shown in FIG. 5. Similar to that described above with respect to the messaging system 100 depicted in FIGS. 1-2, the angle 7 of the disclosed embodiment serves to convert a writing force F_{W} into a downward component F_{D} and a horizontal component F_{H}, as depicted in FIG. 4. So configured, the downward component F_{D} is sufficient to increase a frictional force between the support structure 202 and the surface 5 to prevent the messaging system 200 from sliding along the surface 5 in response to the writing force F_{W}.

As mentioned above, the message board 204 of the embodiment disclosed in FIGS. 3-5 may include a dry-erase board, a chalkboard, a glass substrate, a ceramic tile, a cork-board and/or other substrates including surfaces or materials capable of temporarily or permanently presenting messages. In one embodiment of the messaging system 200, the message board 204 may be interchangeable with one or more auxiliary message boards 204. For example, a message board 204 having a dry-erase surface 206 may be replaced by a message board 204 having a chalkboard messaging surface 206, a corkboard messaging surface 206, a glass messaging surface 206, or any other suitable surface. Similarly, the message board 204 may be replaced by a plurality of ceramic tiles. Further yet, the message board 204 may be replaced by another message board of similar or different core construction and also having a specific motif such as a religious or national holiday motif, a birthday motif, a seasonal motif representative of spring, summer, fall, or winter, a school or institutional motif, or any other motif or collection of indicia, graphics, and/or lettering that may foreseeably be desired by consumers. For example, this messaging system 200 could be combined with a plurality of message boards 204, each depicting a different season,

While the messaging systems 100, 200 have been depicted and described thus far with reference to FIGS. 1-5 as comprising support structures 102, 202 removably supporting a single message board 104, 204, respectively, alternative embodiments of the messaging systems 100, 200 may include a plurality of message boards 104, 204. For example, the support structures 102, 202 of the messaging systems 100, 200 may comprise a plurality of stacked message boards 104, 204, each message board 104, 204 having a thickness that is substantially less than the thickness of the message boards 104, 204 depicted in FIGS. 1-5. So configured, the seat portions 108, 208 of the support structures 102, 202 would simultaneously accommodate the entire plurality of message boards in a stacked manner. In one embodiment, each of the stacked message boards 104, 204 may include a different messaging surface 106, 206 such as a chalkboard messaging surface, a corkboard messaging surface, a glass messaging surface, or any other suitable surface or combination of such surfaces. In an alternative embodiment, each of the stacked message boards 104, 204 may include a distinct motif or theme depicted thereon. The themes or motifs may include religious or national holiday motifs, birthday motifs, seasonal motifs representative of spring summer, fall, or winter, school or institutional motifs, or any other motifs or collection of indicia, graphics, and/or lettering that may foreseeably be desired by consumers. For example, in one embodiment, the messaging systems 100, 200 may include seven message boards 104, 204, each message board or panel being decorated or populated with information corresponding to a particular day of the week. So configured, a user could substitute the foremost message board 104, 204 with one of the remaining message boards 104, 204 to thereby change the appearance, the finish, and/or the content of the messaging surface 106, 206.

Another alternative embodiment of the messaging systems 100, 200 may support a single transparent or translucent message board 104, 204 as well as a decorative panel, which does not comprise a messaging surface. For example, the decorative panel may be positioned behind the transparent or translucent message hoard 104, 204, thereby being visible through the message board 104, 204 and providing, the desired decorative effect to the messaging system 100, 200. The decorative panel may include a cardboard panel, a cloth panel, a paper panel, a vinyl panel, or a panel constructed of generally any material capable of providing the desired decorative effect through the transparent or translucent message board 104, 204. In another alternative embodiment, the messaging system 100, 200 may include a plurality of decorative panels. The plurality of decorative panels may be stacked behind the transparent or translucent message board 104, 204 and may be substituted for each other to achieve different appearances to the messaging systems 100, 200. Similar to the plurality of message boards 104, 204 described above, each of the plurality of decorative panels may include a distinct motif or theme depicted thereon. The themes or motifs may include religious or national holiday motifs, birthday motifs, seasonal motifs representative of spring, summer, fall, or winter, school or institutional motifs, or any other motifs or collection of indicia, graphics, and/or lettering that may foreseeably be desired by consumers.

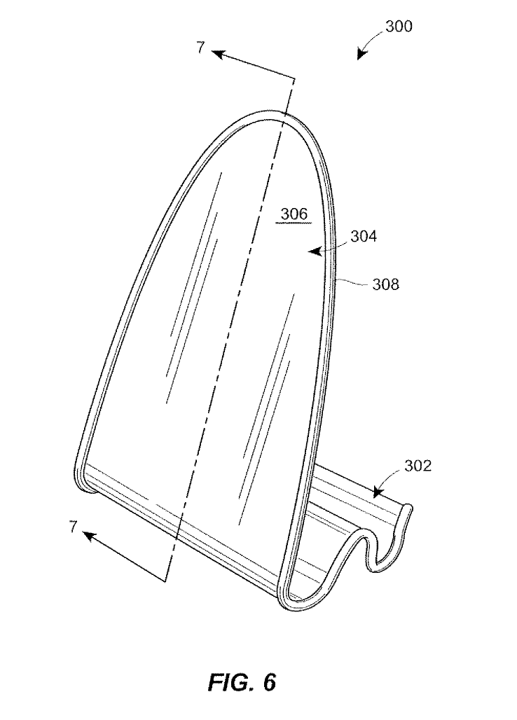

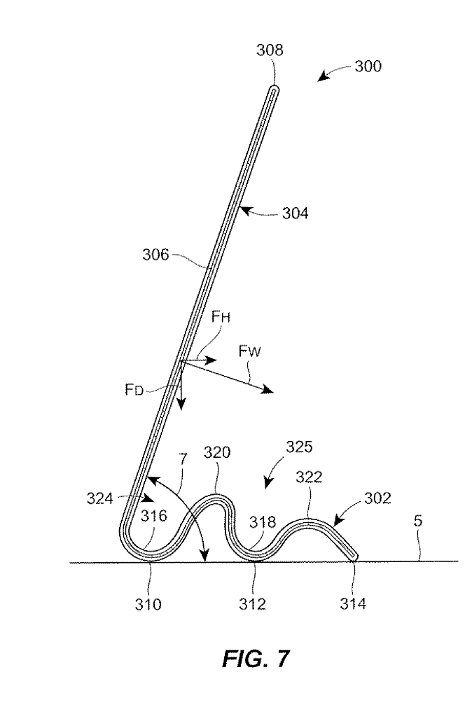

FIGS. 6-7 depict another messaging system 300 constructed in accordance with the present disclosure. Similar to the messaging systems 100, 200 described above, the messaging system 300 generally includes a support structure 302 and message board 304. The support stricture 302 is adapted to support the message board 304 on a flat horizontal surface 5 (shown in FIGS. 7) such as a kitchen counter, an office desk, a table, or any other practical location. The message board 304 includes an oblong member resembling approximately half of an ellipse, but the shape of the message board 304 need not be so limited. The message board 304 has a messaging surface 306 adapted to temporarily present messages. As described above with respect to messaging systems 100, 200, various embodiments of the message board 304 of the embodiment disclosed in FIGS. 6-7 may include a dry-erase board, a chalkboard, a glass substrate, a ceramic tile, a cork-board and/or other substrates including surfaces or materials capable of temporarily or permanently presenting messages.

With continued reference to FIGS. 6 and 7 the message board 304 and the support structure 302 are integrally formed as one-piece. However, the message board 304 could alternatively be received in a seat support (not shown) disposed in a base providing the support structure 302. In the embodiment depicted in FIGS. 6-7, the message board 304 and support structure 302 are formed of sheet metal through an extruding and/or rolling operation. Additionally, the messaging board 304 as shown includes a bead 308 extending around a periphery of the message board 304 and support structure 302. In one embodiment, the bead 308 includes a rubber bead for increasing friction forces between the messaging system 300 and surface 5.

The messaging system 300 includes a first support surface 310, a second support surface 312, and a third support surface 314. However, not necessarily all of the support surfaces 310, 312, 314 are required to adequately support the messaging system 300 on the horizontal surface 5. Additionally, the support structure 302 includes a first concave surface 316, a second concave surface 318, a first convex surface 320, and a second convex surface 322. Each of the concave surfaces 316, 318 and convex surfaces 320, 322 are elongated and extend the width of the support structure 302. So configured, the first concave and second concave surfaces 316, 318 can otherwise serve as storage components 324, 325. The storage components 324, 325 are adapted to receive, retain and conceal markers, for example, such as those discussed above and depicted in phantom in FIGS. 1 and 4.

Accordingly, the storage components 324, 325 of the messaging, system 300 depicted in FIGS. 6-7 are each adapted to receivingly support and retain markers, for example, in a position that is substantially hidden or out of view from an individual with a perspective directed at the messaging surface 306 on the message board 304. Furthermore, the storage components 324, 325 of the disclosed embodiment provide easily accessible storage components 324, 325 making storage and retrieval of the markers simple and efficient.

Similar to that described above with respect to the messaging systems 100, 200, the message board 304 of the messaging system 300 depicted in FIGS. 6 and 7 extends from the support structure 302 at an angle 7. The message board 304 is therefore cantilevered at the angle 7 from the support structure 302. Accordingly, the messaging system 300 inherently includes a moment acting on the message board 304 in the clockwise direction relative to the orientation of the message board 304 of FIG. 7. The support structure 302 therefore and, more particularly, the support surfaces 312 and 314 counteract the moment to maintain the predetermined disposition of the messaging system 300 and prevent the message board 304 from tipping.

Additionally, similar to messaging systems 100 and 200, the angle 7 of the disclosed embodiment serves to convert a writing force F_{W} applied to message board 304 into a downward component F_{D} and a horizontal component F_{H}, as depicted in FIG. 7. So configured, the downward component F_{D} is sufficient to increase a frictional force between the support structure 302 and the surface 5 and thereby prevent the messaging system 300 from sliding along the surface 5 in response to the writing force F_{W}. Furthermore, in the embodiment depicted, the bead 308 described above can aid in preventing the messaging device from sliding on the surface in response to the writing force F_{W}. Specifically, in the disclosed embodiment, the bead 308 may include a rubber bead extending around the periphery of the messaging system 300 including along the first, second, and third support surfaces 310, 312, 314. So configured, the rubber bead 308 would increase the friction between the messaging system 300 and the surface 5, thereby minimizing the opportunity for slippage.

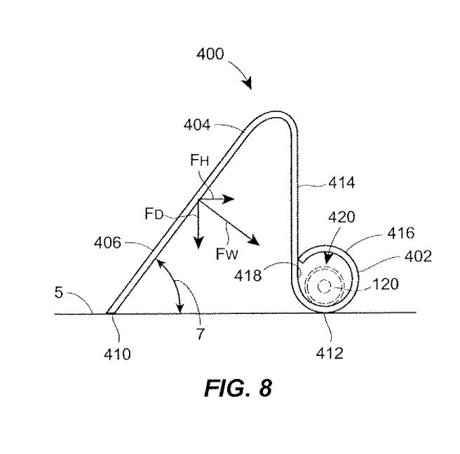

FIG. 8 depicts another messaging system 400 constructed in accordance with the present disclosure. Similar to the messaging systems 100, 200, and 300 described above, the messaging system 400 generally includes a support structure 402 and a message board 404. The support structure 402 is adapted to support the message board 404 on a flat horizontal surface 5 such as a kitchen counter, an office desk, a table, or any other practical location. The message board 404 includes a generally flat rectangular member, but need not be limited to such. The message board 404 has a messaging surface 406 adapted to temporarily present messages. As described above with respect to messaging systems 100, 200, 300, various embodiments of the messaging surface 406 may include a dry-erase board, a chalkboard, a glass substrate, a ceramic tile, a cork-board and/or other substrates including surfaces or materials capable of temporarily or permanently presenting messages.

With continued reference to FIG. 8, the message board 404 and the support structure 402 are integrally formed as one-piece. However, the message board 404 could alternatively be formed as a separate member and affixed to the support structure 402. In the embodiment depicted, the message board 404 and support structure 402 are formed of sheet metal through an extruding and/or rolling operation, but the messaging system can be manufactured using any suitable method. Additionally, the messaging system 400 may include a bead (not shown) similar to the bead 308 disclosed with respect to the messaging systems 300 discussed above and extending around a periphery thereof.

The message board 404 of the messaging system 400 includes a first support surface 410. The support structure 402 of the messaging system 400 includes a second support surface 312. The support surfaces 410, 412 support the messaging system 400 on the horizontal surface 5. Additionally, the support structure 402 includes an upstanding plate 414 and a roll portion 416. The roll portion 416 defines a concave surface 418. The concave surface 418 is disposed on the support structure 402 and includes a width dimension substantially equal to a width dimension of the support structure 402. So configured, the concave surface 418 serves as a storage component 420. The storage component 420 is adapted to receive, retain and conceal a marker 120, as depicted in phantom.

Accordingly, the storage component 420 of the messaging system 400 depicted in FIG. 8 is adapted to receivingly support and retain a marker, for example, in a position that is substantially hidden or out of view from an individual with a perspective directed at the messaging surface 406 on the message board 404 when properly oriented on the surface 5. Additionally, because the storage component 420 of the messaging system 400 depicted in FIG. 8 curves up and over the concave surface 418, it substantially conceals the marker 120 from view of an individual above or behind the messaging system 400 as well. Furthermore, the storage component 420 of the disclosed embodiment provides an easily accessible storage component 420 making storage and retrieval of the marker simple and efficient.

Similar to that described above with respect to the messaging systems 100, 200, 300, the message board 404 of the messaging system 400 depicted in FIG. 8 extends from the surface 5 at an angle 7. Accordingly, the messaging system 400 inherently includes a moment acting on the message board 404 in the clockwise direction relative to the orientation of FIG. 8. The support structure 402 and, more particularly, the upstanding plate 414 and the support surface 412 therefore counteract the moment to maintain the predetermined disposition of the messaging system 400 and thereby prevent the message board 404 from tipping.

Additionally, similar to that described above with reference to messaging systems 100, 200, 300, the angle 7 of the disclosed embodiment serves to convert a writing force F_{W} into a downward component F_{D} and a horizontal component F_{H}, as depicted in FIG. 8. So configured, the downward component F_{D} is sufficient to increase a frictional force between the support structure 402 and the surface 5 and prevent the messaging system 400 from sliding along the surface 5 in response to the writing force F_{W}.

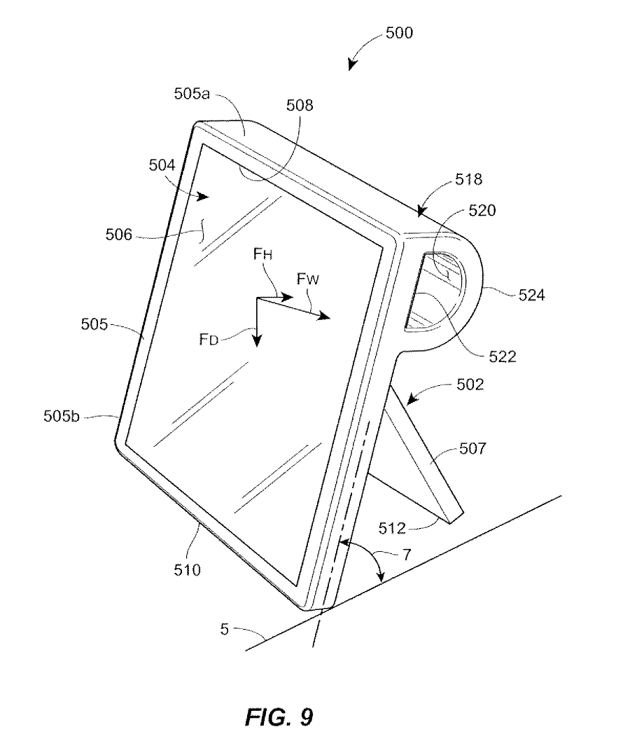

FIGS. 9-11 depict another messaging system 500 constructed in accordance with the present disclosure. Similar to the messaging systems 100, 200, 300, 400 described above, the messaging system 500 generally includes a support structure 502 and a message board 504. The support structure 502 is adapted to support the message board 504 on a flat horizontal surface 5 such as a kitchen counter, an office desk, a table, or any other practical location. The support structure 502 of the embodiment depicted includes a frame 505 and a leg 507. The message board 504 includes a messaging surface 506 adapted to temporarily present messages. As described above with respect to messaging systems 100, 200, 300, 400, various embodiments of the message board 504 may include a dry-erase board, a chalkboard, a glass substrate, a ceramic tile, a cork-board and/or other substrates including surfaces or materials capable of temporarily or permanently presenting messages.

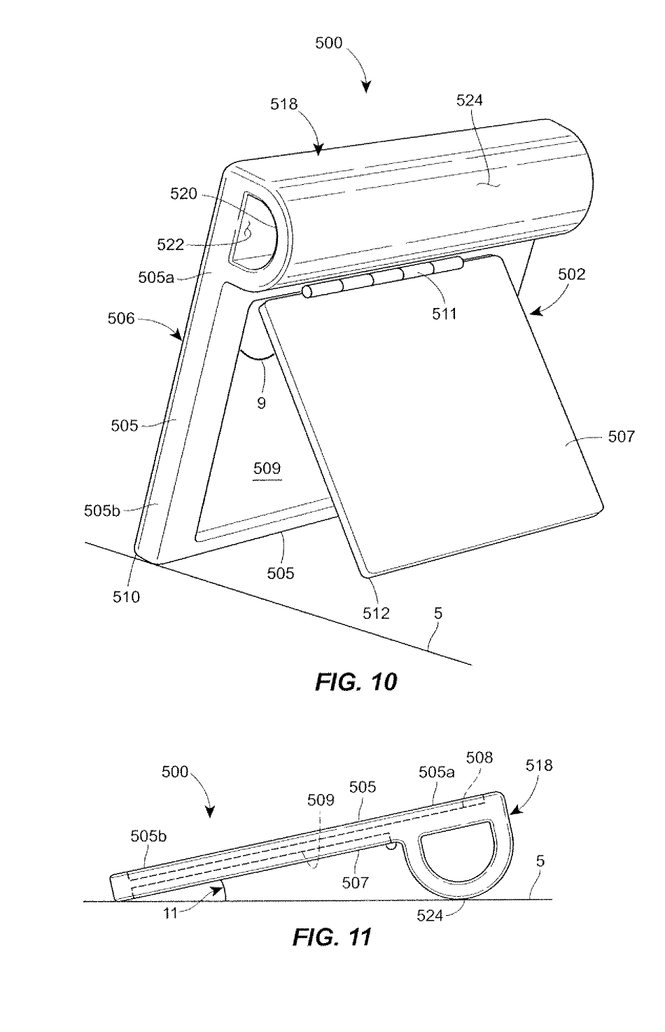

The frame 505 of the support structure 502 includes an upper portion 505a, a lower portion 505b, a generally rectangular front cavity 508, a generally rectangular rear cavity 509 (shown in FIGS. 10 and 11), and a storage component 518. The front cavity 508 in the frame 505 is adapted to contain the message board 504. In one embodiment, the message board 504 may be adhered or fixed within the front cavity 508.

The storage component 518 includes a hollow member defining opposing open ends. The storage component 518 is formed integrally with the upper portion 505a of the frame 505 at a location that is opposite the message board 504. In the embodiment disclosed, the storage component 518 includes a generally semicylindrical inner surface 520, a generally flat inner surface 522, and a generally semicylindrical outer surface 524. So configured, the storage component 518 is adapted to receivingly support and retain a marker 120, 121 (not shown) in engagement with the inner surfaces 520, 522 of the storage component 518. Thus, the storage component 518 is capable of storing a marker 120, 121, for example, in a position that is substantially hidden or out of view from an individual with a perspective directed at the messaging surface 506 of the message board 504. Additionally, because the storage component 518 wraps around to define a generally semicircular cross-section, the storage component 518 conceals a marker 120, 121 stored therein from an individual with a perspective toward the rear and the top of the messaging system 500. Furthermore, tile storage component 518 of the disclosed messaging system 500 provides an easily accessible storage component 518 making storage and retrieval of the marker 120, 121 simple and efficient.

As mentioned above, the support structure 502 additionally includes a leg 507. As depicted in FIG. 10, the leg, 507 is a generally flat rectangular member pivotally coupled to the frame 505 via a hinge 511. Accordingly, the leg 507 is pivotable about the hinge 511 to be moved between a display position, which is depicted in FIGS. 9 and 10, and a stored position, which is depicted in FIG. 11.

Referring specifically to FIG. 11 when the leg 507 of the support structure 502 is in the stored position, the leg 507 is disposed and potentially retained in the rear cavity 509 of the frame 505. So configured, the messaging system 500 may be positioned on the flat surface 5 and supported thereon by the lower portion 505b of the frame and the outer surface 524 of the storage component 518. Due the shape of the storage component 518, the outer surface 524 supports the frame 505 on the flat surface 5 at a slight angle 11. In the disclosed form, the angle 11 provides for an ergonomically positioned messaging system 500, thereby enabling a user to comfortably write and/or draw on the messaging surface 506. In one embodiment, the angle 11 may be generally any angle between approximately 5 degrees and approximately 25 degrees. In other embodiments, however, it should be appreciated that the angle 11 may generally include any angle capable of serving the principles of the present disclosure.

Referring back to FIG. 9, when the leg 507 is in the display position, the leg 507 and frame 505 support the message board 504 at an angle 7 relative to the surface 5. More specifically, the lower portion 505b of the frame 505 includes a support surface 510 engaging the surface 5 and the leg 507 includes a support surface 512 engaging the surface 5. In the display position depicted in FIGS. 9 and 10, the support surfaces 510, 512 are spaced apart, thereby defining an angle 9 between the frame 505 and the leg 507. In one embodiment, for example, the angle 7 between the message board 504 and the surface 5 can be generally any angle between approximately 45 degrees and approximately 75 degrees. Additionally, the angle 9 between the frame 505 and the leg 507, when in the display position, may be generally any angle between approximately 15 degrees and approximately 45 degrees. However, it should be appreciated that the angles 7 and 9 may include any angles capable of serving the principles of the present disclosure.

Similar to that described above with respect to the messaging systems 100, 200, 300, 400, the angle 7 of the message board 504 generates a moment acting on the frame 505 and message board 504. The moment acts into the messaging surface 506 and in the clockwise direction relative to the orientation of FIG. 9, for example. The support structure 502 and, more particularly, the leg 507 therefore counteracts the moment to maintain the predetermined disposition of the messaging system 500 and thereby prevent the frame 505 and message board 504 from tipping.

Additionally, similar to that described above with reference to messaging systems 100, 200, 300, 400, the angle 7 of the disclosed embodiment serves to convert a writing force F_{W} into a downward component F_{D} and a horizontal component F_{H}, as depicted in FIG. 9. So configured, the downward component F_{D} is sufficient to increase a frictional force between the support surfaces 510, 512 of the frame 505 and leg 507, respectively, and the surface 5 to prevent the messaging system 500 from sliding along the surface 5 in response to the writing force F_{W}.

While the frame 505 of the messaging system 500 depicted in FIGS. 9-11 has been disclosed as having an open ended storage component 518, an alternate embodiment of the frame 505 may further include a cap that is removably insertable into the storage component 518. So configured, the cap would completely close the storage component 518 and further conceal the marker 120, 121, for example. The cap could be coupled to one of the inner surfaces 520, 522 or the outer surface 524 of the storage component 518 by various mechanisms, e.g., a living hinge, if desired. Alternatively, in one embodiment, the storage component 518 may not include two open ends, but rather, one open end and one closed end.

It should be understood that while the above-described messaging systems 100, 200, 300, 400, 500 have been disclosed as including a dry-erase surface, alternate embodiments may include any type of writing surface, including but not limited to a chalkboard surface, a glass surface, or a ceramic tile surface, as discussed above, or any combination of these surfaces. Additionally, while the above-described messaging systems 100, 200, 300, 400, 500 have been described as including a single type of messaging surface, alternate embodiments may include multiple messaging surfaces. For example, one alternate embodiment m ay include a dry-erase surface adjacent to a separate chalkboard surface, and/or a separate corkboard surface. Still further, another alternate embodiment of the messaging systems 100, 200, 300, 400, 500 may include a clipping device disposed on the messaging board for temporarily or permanently retaining objects such as notes, markers, menus, memoranda, or any other object one may desire to post on such a messaging system.

In light of the foregoing, it should be appreciated that a messaging system according to the principles of the present disclosure provides a highly versatile, portable and interchangeable messaging system providing easily accessible storage for a writing instrument. The messaging systems 100, 200 disclosed herein advantageously allow a consumer to easily interchange the message boards such that message boards having different themes or motifs may be implemented to express interest in a specific holiday, occasion, and/or celebration. Additionally, each of the messaging systems 100, 200, 300, 400, 500 disclosed herein provides a fashionable messaging system that is easily viewable and readable when disposed on a table or counter, due to the ergonomic angle of the message boards. The angle that the message boards are disposed relative to the horizontal surface advantageously provides a freestanding, non-slip messaging system adaptable to a variety of table-top surfaces.

Finally, it should be appreciated that the foregoing description merely provides examples of messaging devices in accordance with the present disclosure and that modifications and variations thereon are intended to be within the scope of the claims.

What is claimed:

1. A messaging system, comprising:
a message board having a messaging surface adapted to at least temporarily present messages;
a freestanding support structure adapted to support the message board for display on a horizontal surface; and
an instrument storage surface disposed behind the message board relative to the messaging surface such that the instrument storage surface is adapted to store a writing instrument.

2. The messaging system of claim 1, wherein the instrument storage surface is further adapted to store the writing instrument in a position that is substantially hidden when the messaging surface is viewed.

3. The messaging system of claim 1, wherein the messaging system further comprises a writing instrument.

4. The messaging system of claim 3, wherein the writing instrument is a marker.

5. The messaging system of claim 1, wherein the instrument storage surface is disposed between the message board and the freestanding support structure.

6. The messaging system of claim 1, wherein the instrument storage surface is adapted to releasably receive the writing instrument.

7. The messaging system of claim 1, wherein the instrument storage surface is integrally formed with at least one of the message board or the freestanding support structure.

8. The messaging system of claim 1, wherein the message board and the freestanding support structure are integrally formed.

9. The messaging system of claim 1, wherein the message board extends from the freestanding support structure at an angle between approximately 45 degrees and approximately 75 degrees relative to the horizontal surface.

10. The messaging system of claim 1, wherein the message board is cantilevered from the support structure.

11. The messaging system of claim 1, wherein the instrument storage surface comprises at least one of a concave surface or a cylindrical cavity formed on the freestanding, support structure.

12. The messaging system of claim 1, wherein the message board is detachable from the freestanding support structure.

13. The messaging system of claim 12, wherein the messaging system includes a plurality of interchangeable message boards, each of the plurality of message boards including a distinct decorative motif.

14. The messaging system of claim 1, wherein the support structure comprises a pivotable leg for supporting the message board for display.

15. A freestanding messaging system, comprising:
a messaging structure;
a support structure adapted to detachably receive and support the messaging structure at an angle for display on a horizontal surface; and
a messaging surface disposed on the messaging structure adapted to at least temporarily present messages.

16. The freestanding messaging system of claim 15, wherein the messaging structure is cantilevered from the support structure.

17. The freestanding messaging system of claim 15, further comprising an instrument storage component disposed on the support structure at a location behind the messaging structure relative to the messaging surface such that the instrument storage surface is adapted to store a writing instrument in a position that is substantially hidden when the messaging surface is viewed.

18. The freestanding messaging system of claim 15, wherein the instrument storage component comprises at least one of a concave surface or a cylindrical cavity disposed on the support structure.

19. The freestanding messaging system of claim 15, wherein the messaging structure may be freely interchangeable with a plurality of auxiliary messaging structures each comprising a distinct decorative motif

20. A messaging system, comprising:
a message board;
a messaging surface disposed on the message board and adapted to at least temporarily present a message; and
a support structure adapted to support the message board on a horizontal surface such that the messaging surface is disposed at an angle relative to the horizontal surface, at least one of the message board or the support structure including an instrument storage component adapted to receive a messaging instrument, the instrument storage component disposed behind the message board relative to the messaging surface such that tie instrument storage surface is adapted to store a writing instrument in a position that is substantially hidden when the messaging surface is viewed.

21. The messaging system of claim 20, further comprising a marker adapted to selectively provide messages on the messaging surface.

22. The messaging system of claim 20, wherein the instrument storage component comprises at least one of a concave surface or a cylindrical cavity.

23. The messaging system of claim 20, wherein the message board and support structure are detachable such that the message board may be freely interchangeable with a plurality of auxiliary message boards, each comprising a distinct decorative motif.

24. The messaging system of claim 20, wherein the support structure comprises a pivotable leg for supporting the message board for display.
